(19) United States
(12) Patent Application Publication
(10) Pub. No.: US 2013/0026768 A1
(43) Pub. Date: Jan. 31, 2013

(54) PASSIVE DOOR LOCK DEVICE

(71) Applicants: Douglas A. Nolte, Owatonna, MN (US); Yoshikazu Nakanishi, Owatonna, MN (US); Manabu Shimoji, Owatonna, MN (US)

(72) Inventors: Douglas A. Nolte, Owatonna, MN (US); Yoshikazu Nakanishi, Owatonna, MN (US); Manabu Shimoji, Owatonna, MN (US)

(21) Appl. No.: 13/463,220

(22) Filed: May 3, 2012

Related U.S. Application Data
(60) Provisional application No. 61/482,795, filed on May 5, 2011.

(51) Int. Cl. E05C 7/04; E05C 9/04

(52) U.S. Cl. 292/42

(57) ABSTRACT

According to embodiments of the invention, a device for securing the passive panel of a double door assembly includes a rotatable handle for retracting and extending remote bolts to secure the passive panel to the door frame, and a lock bolt that can be extended and retracted by a separate control to secure the passive panel to the active panel.

### RELATED APPLICATIONS

The present application claims the benefit of U.S. Provisional Patent Application No. 61/482,795, filed May 5, 2011, and entitled PASSIVE DOOR LOCK DEVICE, said application being hereby fully incorporated herein by reference.

### FIELD OF THE INVENTION

The present invention relates to door lock devices, and more particularly to door lock devices for multi-panel doors.

### BACKGROUND OF THE INVENTION

Passive door lock devices are commonly used where two or more hinged swinging door panels are installed in a single wall opening. The door assembly includes the two swinging panels hinged at opposite sides into two vertical rails of a frame attached to the wall opening. The frame also consists of a header along the top of the opening and a threshold along the bottom of the opening. The free edges of the two swinging doors come together in the middle of the opening and act as support structure for hardware to secure the door panels to the frame structure. One of the door panels contains hardware similar to what is found on any single door application with latch bolts, deadbolts, and possibly remote bolt points in the case of multi-point hardware. This panel is often referred to as the active panel. The other panel commonly contains strikes to accept the bolts of hardware in the active panel. This panel is often referred to as the passive panel. In order to ensure that both panels are secured in the opening, the passive panel must somehow be secured to the frame so it may act as a mooring for the active panel.

### SUMMARY OF THE INVENTION

In embodiments of the invention, a swinging passive panel is secured by shoot bolts extending vertically out of the top and bottom corners of the free edge of the panel into strikes on the frame header and threshold. Strikes may be attached to the passive panel on a strip of material, often referred to as an astragal, attached to the free edge of the passive panel. The astragal is attached covering the passive door lock and provides clearance for latch bolts, deadbolts and remote bolts of the active panel to extend into the passive panel.

According to embodiments of the invention, a device for securing the passive panel of a double door assembly includes a rotatable handle for retracting and extending remote bolts to secure the passive panel to the door frame, and a lock bolt that can be extended and retracted by a separate control to secure the passive panel to the active panel.

According to an embodiment, a passive door lock device for securing a first door panel of a double-door assembly to a second door panel of the double-door assembly and simultaneously to a frame of the double-door assembly includes a central cassette portion receivable in a mortise in the door panel. The cassette portion includes a housing, and a locking bolt in the housing. The locking bolt is selectively shiftable between a retracted position in which the locking bolt is substantially contained within the housing, and an extended position in which a portion of the locking bolt extends from the housing so as to be engaged with the second door panel. The device further includes a lock bolt driver assembly for shifting the locking bolt between the retracted position and the extended position, a rotatable handle assembly, a pair of drive bars operably coupled with the rotatable handle assembly, and a pair of remote bolts, each remote bolt operably coupled to a separate one of the drive bars, wherein the remote bolts are selectively shiftable with the rotatable handle assembly between a first retracted position and a second extended position.

In embodiments of the invention, the passive the remote bolts are prevented from shifting from the retracted position to the extended position when the locking bolt is in the retracted position. The remote bolts may be prevented from shifting from the extended position to the retracted position when the locking bolt is in the extended position. The lock bolt driver may be operably coupled with a biasing spring for biasing the lock bolt driver toward both the retracted position of the locking bolt and the extended position of the locking bolt. The biasing spring may be a flat spring.

In other embodiments of the invention, a passive door lock device may provide a tactile indication to a user that the locking bolt is in the extended position or that the locking bolt is in the retracted position. A spring may be operably coupled to at least one of the drive bars for biasing the drive bar to the extended or the retracted position.

In other embodiments, the rotatable handle is rotatable in a first rotational direction relative to a neutral position to shift the remote bolts from the retracted position to the extended position, and the rotatable handle is rotatable in an opposite rotational direction relative to the neutral position to shift the remote bolts from the extended position to the retracted position. The device can include a spring operably coupled to the rotatable handle, the spring arranged to bias the rotatable handle to the neutral position. In embodiments, the drive bars move in opposite directions.

In a further embodiment, a double door assembly includes an active panel and a passive panel, the active panel and the passive panel being separately hinged to a frame, the passive panel including a passive door lock device for securing the passive panel to the active panel and simultaneously securing the passive panel to the frame. The passive door lock device includes a central cassette portion receivable in a mortise in the door panel. The cassette portion includes a housing, and a locking bolt in the housing. The locking bolt is selectively shiftable between a retracted position in which the locking bolt is substantially contained within the housing, and an extended position in which a portion of the locking bolt extends from the housing so as to be engaged with the second door panel. The device further includes a lock bolt driver assembly for shifting the locking bolt between the retracted position and the extended position, a rotatable handle assembly, a pair of drive bars operably coupled with the rotatable handle assembly, and a pair of remote bolts, each remote bolt operably coupled to a separate one of the drive bars, wherein the remote bolts are selectively shiftable with the rotatable handle assembly between a first retracted position and a second extended position.

In embodiments of the invention, the passive the remote bolts are prevented from shifting from the retracted position to the extended position when the locking bolt is in the retracted position. The remote bolts may be prevented from shifting from the extended position to the retracted position when the locking bolt is in the extended position. The lock bolt driver may be operably coupled with a biasing spring for biasing the lock bolt driver toward both the retracted position of the locking bolt and the extended position of the locking bolt. The biasing spring may be a flat spring.

In other embodiments of the invention, a passive door lock device may provide a tactile indication to a user that the locking bolt is in the extended position or that the locking bolt is in the retracted position. A spring may be operably coupled to at least one of the drive bars for biasing the drive bar to the extended or the retracted position.

In other embodiments, the rotatable handle is rotatable in a first rotational direction relative to a neutral position to shift the remote bolts from the retracted position to the extended position, and the rotatable handle is rotatable in an opposite rotational direction relative to the neutral position to shift the remote bolts from the extended position to the retracted position. The device can include a spring operably coupled to the rotatable handle, the spring arranged to bias the rotatable handle to the neutral position. In embodiments, the drive bars move in opposite directions.

A feature and advantage of certain embodiments of the invention is that a lock bolt driver extends a locking bolt which simultaneously locks out the operating handle of the device so as to prevent the remote bolts from being retracted with the operating handle while the locking bolt is extended.

A feature and advantage of certain embodiments of the invention is that the lock bolt driver is spring-loaded so that the user is presented with a tactile indication when the lock bolt driver is operated that the lock bolt driver has reached either of its locked or an unlocked positions, and wherein the lock bolt driver is biased toward the locked or unlocked position.

A feature and advantage of certain embodiments of the invention is that either or both of the drive bars for actuating remote locking points is spring-biased toward the extended or retracted position.

A feature and advantage of certain embodiments of the invention is that the operating handle is spring-loaded so as to return the handle to a neutral position after operation, and so as to prevent or control handle-droop.

A feature and advantage of certain embodiments of the invention is that the upper and lower drive bars for actuating remote locking points are reversed in direction so as to be gravity-balanced. The device may be used with remote locking points in the form of shoot bolts having a reversing mechanism so that an upward movement of the upper drive bar acts to retract the upper shoot bolt, and a corresponding downward movement of the lower drive bar acts to retract the lower shoot bolt.

A feature and advantage of certain embodiments of the invention is that one of the drive bars blocks extension of the locking bolt and lock bolt driver rotation when the remote bolts are retracted, to thereby serve as an indicator to the user that the remote bolts are not extended.

A feature and advantage of certain embodiments of the invention is that when the locking bolt is extended, retraction of the remote bolts is prevented.

### BRIEF DESCRIPTION OF THE FIGURES

The invention may be more completely understood in consideration of the following detailed description of various embodiments of the invention in connection with the accompanying drawings, in which:

FIG. 1 is a side elevation view of a lock assembly according to an embodiment of the invention;

FIG. 2 is a side elevation view of the lock assembly of FIG. 1, depicting modules of the assembly in exploded fashion;

FIG. 3 is a cut-away side elevation view of portions of the assembly of FIG. 1, depicting the assembly in an initial state of operation;

FIG. 4 is a cut-away side elevation view of portions of the assembly of FIG. 1, depicting the assembly with the handle rotated upward to extend the shoot-bolts;

FIG. 5 is a cut-away side elevation view of portions of the assembly of FIG. 1, depicting the assembly with the handle centered and a thumb turn control rotated to lock the shoot-bolts in the extended position;

FIG. 6 is a cut-away side elevation view of portions of the assembly of FIG. 1, depicting the assembly with, the handle centered and the thumb turn control rotated to unlock the shoot-bolts;

FIG. 7 is a cut-away side elevation view of portions of the assembly of FIG. 1, depicting the assembly with the handle rotated downward to retract the shoot-bolts;

FIG. 8 is a cut-away side elevation view of portions of the assembly of FIG. 1, depicting the assembly with the handle centered and the thumb-turn blocked from rotating into position to lock the shoot-bolts until the shoot-bolts are fully engaged in the door frame;

FIG. 9 is a cut-away side elevation view of a portion of the cassette of the assembly of FIG. 1 with the handle rotated upward;

FIG. 10 is a cut-away side elevation view of the portion of FIG. 9 with the handle centered and the shoot bolts in an extended position;

FIG. 11 is a cut-away side elevation view of the portion of FIG. 9 with the handle rotated downward;

FIG. 12 is a cut-away side elevation view of the portion of FIG. 9 with the handle centered and the shoot-bolts in a retracted position;

FIG. 13 is an isometric view of the cassette portion of the assembly of FIG. 1;

FIG. 14 is an isometric view of the locking bolt of the assembly of FIG. 13; and

FIG. 15 is an isometric view of the lock bolt driver of the assembly of FIG. 13.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

### DETAILED DESCRIPTION OF THE PREFERRED EMBODIMENTS

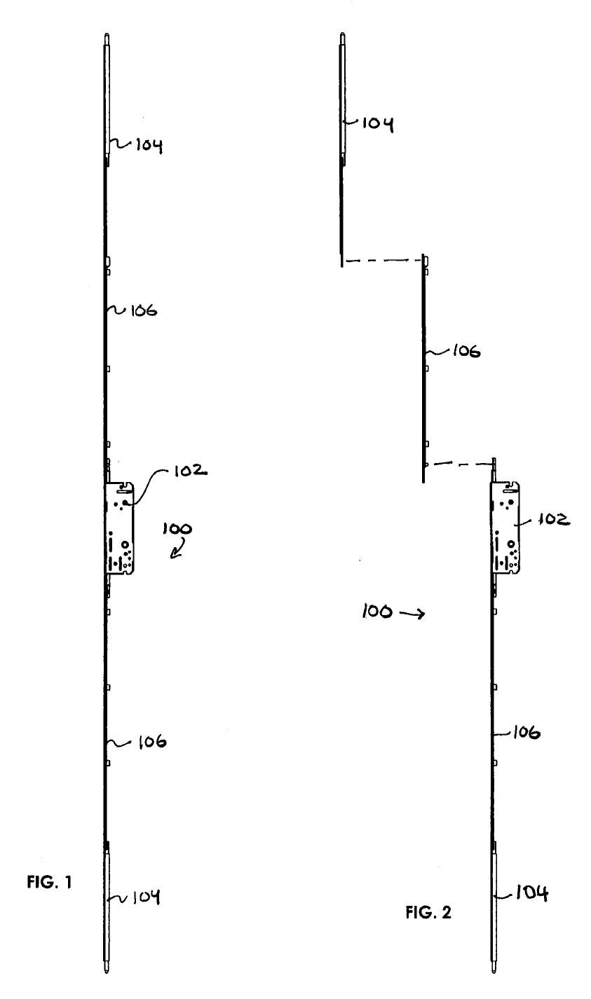

As depicted in FIGS. 1-15, a passive door lock assembly 100 according to embodiments of the invention generally includes center cassette 102 and a pair of remote bolts in the form of shoot bolts 104, operably coupled together by tie-bar assemblies 106. Assembly 100 may be unitary as depicted in FIG. 1 or composed of separable modules as depicted in FIG. 2 to facilitate accommodating doors of varying heights. Further details of shoot bolts 104 are described in U.S. patent application Ser. No. 12/573,532, owned by the owner of the present invention, and hereby fully incorporated herein by reference. Further details of an active door lock assembly that may be useful with the present invention are disclosed in U.S. patent application Ser. No. 12/827,833, also owned by the owners of the present application, said application being hereby fully incorporated herein by reference. Further details of a double door assembly including both active and passive door panels in which passive door lock assembly 100 may be useful are disclosed in U.S. Pat. No. 6,971,686, owned by the owner of the present application and hereby fully incorporated herein by reference.

Center cassette 102 generally includes housing 108 enclosing handle assembly 110, bolt drive assembly 112, and lock control assembly 114. Handle assembly 110 generally includes crank 116, spindle portion 118, handle 120, and handle return spring assembly 121. Crank 116 has upper arm 122 and lower arm 124 extending from barrel portion 126, which also defines gear teeth 128. Handle 120 may have a projection (not depicted) that is generally square in cross-section so as to engage in square recess 130 defined in spindle portion 118, thereby keying rotation of handle 120 to rotation of spindle portion 118 and crank 116.

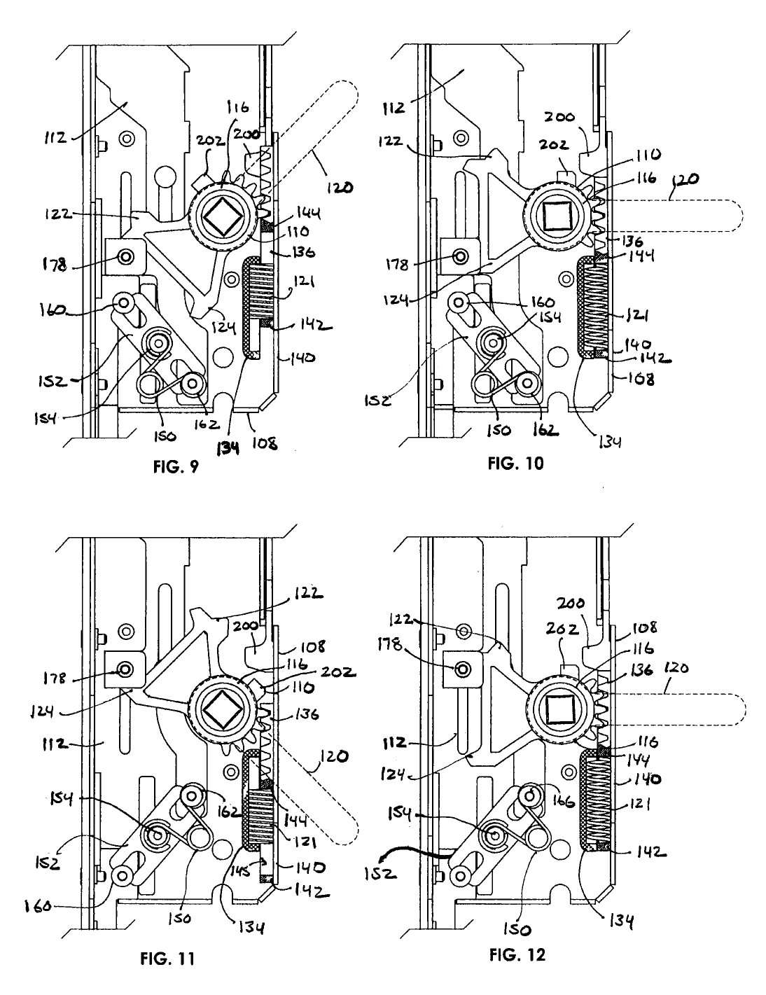

As depicted in FIGS. 9-12, handle return spring assembly 121 generally includes compression spring 132, spring housing 134, and rack 136 defining gear teeth 138. Spring housing 134 is fixed to housing 108, while rack 136 is slidably disposed on rear wall 140 of housing 108. Rack 136 has end-walls 142, 144, which define a recess 145 therebetween.

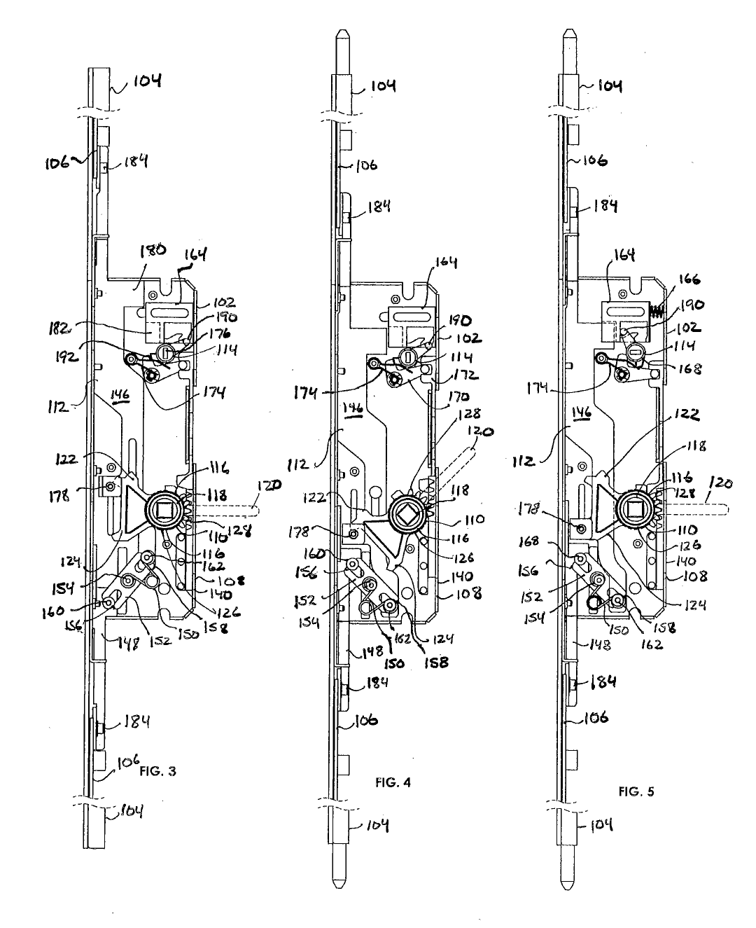

Bolt drive assembly 112 generally includes upper drive bar 146, lower drive bar 148, torsion spring 150, and pivot lever 152. Pivot lever 152 is pivotally attached to housing 108 at pivot 154, and defines forked ends 156, 158. Forked end 156 of pivot lever 152 receives pin 160 on lower drive bar 148, and forked end 158 of pivot lever 152 receives pin 162 on upper drive bar 146. Torsion spring 150 pivots on both pivot 154 and pin 162 as depicted in FIGS. 3-12, and applies a biasing force to hold the mechanism in a first position with the shoot bolts extended and also hold the mechanism in a second position with the shoot bolts retracted.

Lock control assembly 114 generally includes locking bolt 164, biasing spring 166, thumb-turn cam member 168, lever 170, stop bar 172, and spring 174. Locking bolt 164 is horizontally slidable in housing 108 and is biased away from rear wall 140 by biasing spring 166. Cam member 168 is rotatably mounted in housing 108 and defines slot 176 for receiving the spindle of a thumb turn or thumb turn/lock cylinder as is well-known in the field. Stop bar 172 is slidably disposed on rear wall 140.

As depicted in FIGS. 3 and 4, shoot bolts 104 are extended by an upward rotational input from handle 120. Upper arm 122 of crank 116 rotates downward, contacting captured pin 178 in upper drive bar 146 and pushes upper drive bar 146 in a downward direction, thereby registering projection 180 of upper drive bar 146 vertically with undercut 182 in locking bolt 164. As upper drive bar 146 moves downward, pivot lever 152 pivots, driven by the engagement of pin 162 in forked end 158. As pivot lever 152 pivots, lower drive bar 148 is driven upward through the engagement of pin 160 in forked end 156. Drive bars 146, 148, are coupled to tie bars 106 by tie bar pins 184. Tie bars 106 are connected to, and extend, shoot bolts 104 vertically into strikes located on the door frame header or threshold of the double door assembly (not depicted). Simultaneously, as depicted in FIGS. 9-10, gear teeth 128 on crank 116 drive rack 136 vertically. Recess 145 in rack 136 longitudinally contains half of compression spring 132. The other half of compression spring 132 is contained in spring housing 134. As rack 136 is driven vertically up, recess 145 shifts upward, compressing compression spring 132 against the top wall of spring housing 134, and thereby applying an increasing downward biasing force on rack 136, and by transmission, a clockwise biasing force on crank 116 so as to bias handle 120 back toward a centered position. As handle 120 is released, torsion spring 150 holds operation bars 146, 148, in the extended position. Compression spring 132 urges rack 136 downward, returning handle 120 to the neutral, centered position depicted in FIG. 10.

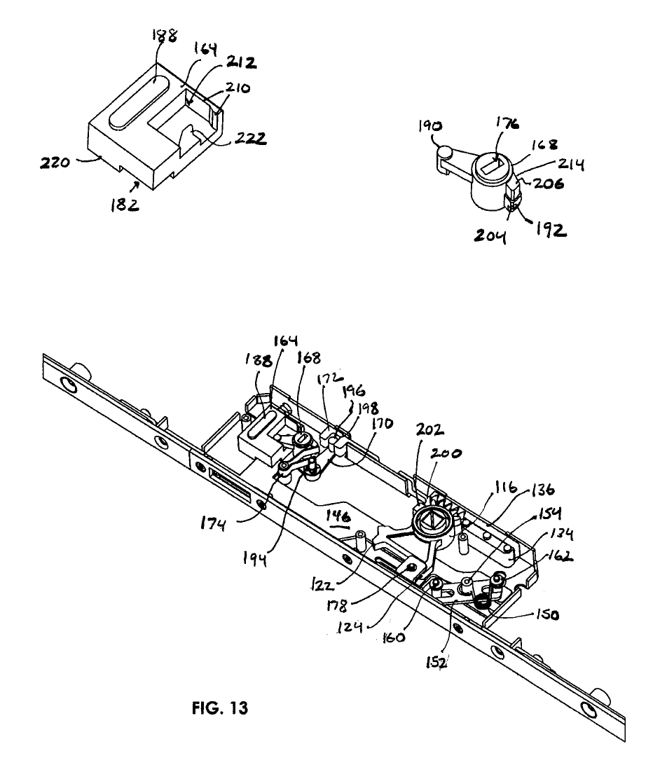

As depicted in FIGS. 4-5, once upper operation bar 146 is in the extended position, locking bolt 164 is extended horizontally by a rotation of a thumb turn or thumb turn/lock cylinder common in the field (not shown), having a spindle engaged in slot 176. As cam member 168 rotates, locking bolt 164 assisted by biasing spring 166 and guided by slots in housing 108 and cover (not depicted) and guides 188 on both sides of locking bolt 164, horizontally follows a boss 190 (see FIG. 13) on cam member 168. Undercut 182 in locking bolt 164 overlaps projection 180 of upper operation bar 146, blocking any upward motion of upper operation bar 146, thereby effectively locking shoot bolts 104 in the extended position. Simultaneously, cam surface 192 (see FIG. 13) drives lever 170 to rotate about pin 194. Boss 196 on lever 170 rotates down. Slot 198 in stop bar 172 is positioned by boss 196 as it rotates downward. Stop bar 172 moves vertically downward such that blocking lobe 200 at the other end of stop bar 172 moves in proximity with tab 202 on crank 116, blocking rotation of crank 116, and thereby handle 120 from retracting shoot bolts 104. Simultaneously, spring 174 contacts corner 204 of lobe 206 of cam member 168, holding cam member 168 in the locked position.

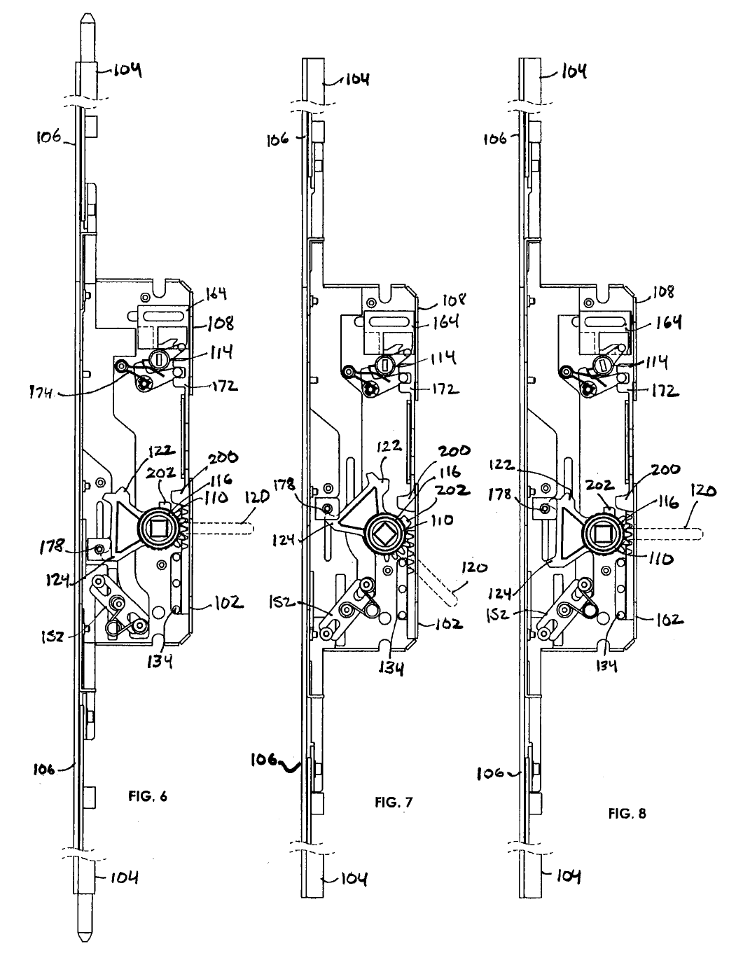

As depicted in FIG. 6, locking bolt 164 is retracted by reversing the rotation of the thumb turn or thumb turn/lock cylinder, thereby rotating cam member 168 in the opposite direction. As cam member 168 rotates, boss 190 (see FIGS. 13-15) contacts surface 210 in cavity 212 of locking bolt 164, thereby driving locking bolt 164 to the retracted position. Simultaneously, as cam member 168 rotates to retract locking bolt 164, cam surface 192 (see FIG. 13) on lobe 206 of cam member 168 contacts the other end of lever 170, shifting boss 196 up and lifting stop bar 172 vertically upward. This moves blocking lobe 200 away from tab 202 on crank 116, enabling rotation of crank 116. Simultaneously, lobe 36 on cam member 168 has surface 214 that when contacted by spring 174 holds locking bolt 164 in the unlocked position.

As depicted in FIG. 7, shoot bolts 104 are retracted by a downward rotational input from handle 120. Lower arm 124 of crank 116 rotates upward and contacts captured pin 178 in upper drive bar 146 and pushes upper drive bar 146 in an upward direction. Pin 162 of upper drive bar 146 rotates pivot lever 152, which drives pin 160 of lower drive bar 148 in a downward direction. Drive bars 146, 148, drive tie bars 106 via tie bar pins 184. Tie bars 106 drive shoot bolts 104 to the retracted position, disengaging shoot bolts 104 from strikes in the door frame (not depicted). Simultaneously, as in FIGS. 11-12, gear teeth 128 on crank 116 drive rack 136 in a vertically downward direction. Compression spring 132 contained in the shrinking compartment composed of recess 145 spring housing 134 is compressed. When handle 120 is released, torsion spring 150 holds drive bars 146, 148, in the retracted position while compression spring 132 drives handle 120 back to the centered neutral position through rack 136 and gear teeth 128 on crank 116.

As depicted in FIG. 8, shoot bolts 104 are in the retracted position, projection 180 of upper drive bar 146 is in a position vertically registered with a non-undercut section 220 of locking bolt 164. When non-undercut section 220 contacts projection 180, it blocks further horizontal motion of locking bolt 164. This enables cam member 168 to rotate only until boss 190 contacts boss 222 on locking bolt 164. Slot 176 in cam member 168 transmits a stopping force to a thumb turn/spindle assembly engaged in the slot. When the thumb turn/spindle assembly is released, spring 174 is contacting lobe surface 214 on cam member 168, driving cam member 168 back to the unlocked position. This serves as an indicator that the shoot bolts 104 are not securely engaged in the door frame strikes and that the shoot bolts 104 must be extended before the thumb turn can be actuated to lock the passive panel.

The embodiments above are intended to be illustrative and not limiting. Additional embodiments are encompassed within the scope of the claims. Although the present invention has been described with reference to particular embodiments, those skilled in the art will recognize that changes may be made in form and detail without departing from the spirit and scope of the invention. For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A passive door lock device for securing a first door panel of a double-door assembly to a second door panel of the double-door assembly and simultaneously to a frame of the double-door assembly, the device comprising:
a central cassette portion receivable in a mortise in the door panel, the cassette portion including:
a housing;
a locking bolt in the housing, the locking bolt selectively shiftable between a retracted position in which the locking bolt is substantially contained within the housing, and an extended position in which a portion of the locking bolt extends from the housing so as to be engaged with the second door panel;
a lock bolt driver assembly for shifting the locking bolt between the retracted position and the extended position;
a rotatable handle assembly;
a pair of drive bars operably coupled with the rotatable handle assembly; and
a pair of remote bolts, each remote bolt operably coupled to a separate one of the drive bars, wherein the remote bolts are selectively shiftable with the rotatable handle assembly between a first retracted position and a second extended position.

2. The passive door lock device of claim 1, in which the remote bolts are prevented from shifting from the retracted position to the extended position when the locking bolt is in the retracted position.

3. The passive door lock device of claim 1, in which the remote bolts are prevented from shifting from the extended position to the retracted position when the locking bolt is in the extended position.

4. The passive door lock device of claim 1, in which the lock bolt driver is operably coupled with a biasing spring for biasing the lock bolt driver toward both the retracted position of the locking bolt and the extended position of the locking bolt.

5. The passive door lock device of claim 4, in which the biasing spring is a flat spring.

6. The passive door lock device of claim 4, in which the biasing spring provides a tactile indication to a user that the locking bolt is in the extended position or that the locking bolt is in the retracted position.

7. The passive door lock device of claim 1, further comprising a spring operably coupled to at least one of the drive bars for biasing the drive bar to the extended or the retracted position.

8. The passive door lock assembly of claim 1, in which the rotatable handle is rotatable in a first rotational direction relative to a neutral position to shift the remote bolts from the retracted position to the extended position, and the rotatable handle is rotatable in an opposite rotational direction relative to the neutral position to shift the remote bolts from the extended position to the retracted position.

9. The passive door lock device of claim 1, further comprising a spring operably coupled to the rotatable handle, the spring arranged to bias the rotatable handle to the neutral position.

10. The passive door lock assembly of claim 1 in which the drive bars move in opposite directions.

11. A double door assembly comprising an active panel and a passive panel, the active panel and the passive panel being separately hinged to a frame, the passive panel including a passive door lock device for securing the passive panel to the active panel and simultaneously securing the passive panel to the frame, the passive door lock device comprising:
a central cassette portion received in a mortise in the passive door panel, the cassette portion including:
a housing;
a locking bolt in the housing, the locking bolt selectively shiftable between a retracted position in which the locking bolt is substantially contained within the housing, and an extended position in which a portion of the locking bolt extends from the housing so as to be engaged with the active door panel;
a lock bolt driver assembly for shifting the locking bolt between the retracted position and the extended position;
a rotatable handle assembly;
a pair of drive bars operably coupled with the rotatable handle assembly; and
a pair of remote bolts, each remote bolt operably coupled to a separate one of the drive bars, wherein the remote bolts are selectively shiftable with the rotatable handle assembly between a first retracted position and a second extended position in which at least one of the remote bolts is engaged with the frame.

12. The double door assembly of claim 11, in which the remote bolts are prevented from shifting from the retracted position to the extended position when the locking bolt is in the retracted position.

13. The double door assembly of claim 11, in which the remote bolts are prevented from shifting from the extended position to the retracted position when the locking bolt is in the extended position.

14. The double door assembly of claim 11, in which the lock bolt driver is operably coupled with a biasing spring for biasing the lock bolt driver toward both the retracted position of the locking bolt and the extended position of the locking bolt.

15. The double door assembly of claim 14, in which the biasing spring is a flat spring.

16. The double door assembly of claim 14, in which the biasing spring provides a tactile indication to a user that the locking bolt is in the extended position or that the locking bolt is in the retracted position.

17. The double door assembly of claim 11, further comprising a spring operably coupled to at least one of the drive bars for biasing the drive bar to the extended or the retracted position.

18. The double door assembly of claim 11, in which the rotatable handle is rotatable in a first rotational direction relative to a neutral position to shift the remote bolts from the retracted position to the extended position, and the rotatable handle is rotatable in an opposite rotational direction relative to the neutral position to shift the remote bolts from the extended position to the retracted position.

19. The double door assembly of claim 11, further comprising a spring operably coupled to the rotatable handle, the spring arranged to bias the rotatable handle to the neutral position.

20. The double door assembly of claim 11 in which the drive bars move in opposite directions.
